(19) United States
(12) Patent Application Publication
(10) Pub. No.: US 2025/0361961 A1
(43) Pub. Date: Nov. 27, 2025

(54) ERRONEOUS CONNECTION PREVENTION METHOD AND ERRONEOUS CONNECTION PREVENTION TOOL

(71) Applicant: JGC Japan Corporation, Yokohama-shi, Kanagawa (JP)

(72) Inventor: Takeshi KOJIMA, Yokohama-shi, Kanegawa (JP)

(21) Appl. No.: 18/871,634

(22) PCT Filed: Jun. 15, 2022
(86) PCT No.: PCT/JP2022/023967

§ 371 Date: Dec. 4, 2024

(51) Int. Cl. F16L 37/10

(52) U.S. Cl. CPC F16L 37/10; F16L 2201/10; F16L 2201/60

(57) ABSTRACT

Preventing erroneous connection of a tube connected for transferring fluid between first and second apparatuses. The tube is surrounded from an outer peripheral side by an erroneous connection prevention tool whose main body portion is configured as an annular member. The tool is attached with identification information associated with connection information indicating a connection destination of the tube. One end side of the tube is connected to a preset connection destination. The erroneous connection prevention tool is moved from one end side to another end side of the tube along the tube. The connection information associated with the identification information of the erroneous connection prevention tool is moved to the other end side is confirmed. Then another end side of the tube is connected to a preset connection destination of an apparatus on another side of the first or second apparatus based on the confirmed connection information.

### TECHNICAL FIELD

The present invention relates to a technique for preventing an erroneous connection when apparatuses are connected to each other with a tube.

### BACKGROUND ART

In a process for manufacturing a biopharmaceutical such as an antibody-drug or a vaccine, cell culture, objective substance purification treatment, or the like may be performed using a resin-made container referred to as a single-use bag (SUB). In addition, an operation of connecting a plurality of SUBs to each other using a resin pipe referred to as a single-use tube (SUT) and transporting a culture solution or a treatment liquid between different SUBs is also performed.

Single-use apparatuses, such as SUBs, SUTs, and connectors that connect these, constitute a process for implementing each piece of processing by connecting the apparatuses that have been radiation sterilized in advance to each other. Therefore, as compared with a stainless-steel container or pipe, cleaning treatment or sterilization treatment after the use of the apparatus is unnecessary, and the verification cost for reducing the occurrence risk of contamination can be greatly reduced.

On the other hand, in the single-use apparatus, apparatuses need to be connected and assembled every time the cell culture or purification treatment is implemented. At this time, if the apparatuses are not correctly connected so as to have a preset connection relationship, contamination accompanying erroneous connections may occur. In particular, a biopharmaceutical factory may be provided with a plurality of processes in a common room. In addition, single-use apparatuses are standardized, and it is often difficult to visually identify individual SUBs and SUTs. For this reason, the assembly of the process using the single-use apparatus is a work that requires a large amount of effort, such as performing reconfirmation to ensure a correct connection relationship by a person in charge other than the assembly worker.

For example, Patent Literature 1 describes a technique for writing and enabling updating maintenance data, identification data, manufacturing data, and the like of a pipe such as a high-pressure pipe in an electronically readable tag, and attaching the tag to a cylindrical object surrounding the pipe. As described above, with the use of the electronically readable tag, the pipes can be individually identified. However, the information itself for individually identifying the pipes is not information for ensuring that the pipe is connected to an accurate connection destination in the assembly operation.

In addition, Patent Literature 2 describes a cable erroneous connection prevention tool having a configuration in which first and second identification tags each including a protruding portion or an insertion portion are provided at a terminal portion of a coaxial cable connecting an antenna and an office building and a portion to be connected of the coaxial cable, and these tags can be inserted to a predetermined position only when shapes of the protruding portion and the insertion portion match. However, as described above, since a standardized general-purpose product is sold as the single-use apparatus used in the biopharmaceutical manufacturing process, the operation of attaching the erroneous connection prevention tool according to the example described in Patent Literature 2 to each single-use apparatus requires a complicated checking operation that is not different from the actual connection operation.

### CITATION LIST

### Patent Literature

Patent Literature 1: Chinese Patent Application Publication No. 105593588
Patent Literature 2: Japanese Utility Model Registration No. 3153662

SUMMARY OF INVENTION

### Technical Problem

The present invention has been made under such a background and provides a technique for preventing erroneous connection of a tube connected for transferring a fluid between a first apparatus and a second apparatus.

### Solution to Problem

The present invention is an erroneous connection prevention method for preventing erroneous connection of a tube connected for transferring a fluid between a first apparatus and a second apparatus different from the first apparatus, the erroneous connection prevention method including the steps of:
using an erroneous connection prevention tool whose main body portion, configured as an annular member, is attached with identification information associated with connection information indicating a connection destination of the tube to the first apparatus or the second apparatus, the identification information for identifying the connection information, and in a state where the erroneous connection prevention tool is disposed so as to surround the tube from an outer peripheral side by the main body portion on one end side of the tube, connecting one end side of the tube to a preset connection destination of an apparatus on one side of the first apparatus or the second apparatus based on the connection information associated with the identification information of the erroneous connection prevention tool;
next, moving the erroneous connection prevention tool from one end side to another end side of the tube along the tube;
confirming the connection information associated with the identification information of the erroneous connection prevention tool moved to the other end side; and
connecting another end side of the tube to a preset connection destination of an apparatus on another side of the first apparatus or the second apparatus based on the confirmed connection information.

The erroneous connection prevention method may include the following features.

(a) A step of connecting one end of the tube in each of the first apparatus and the second apparatus using two erroneous connection prevention tools and a step of moving the erroneous connection prevention tool are performed, and in a step of connecting another end side of the tube to the connection destination, other ends of the tubes are set as the connection destinations. At this time, in a step of confirming the connection information, confirming matching between the pieces of identification information of the erroneous connection prevention tools moved to the other end sides replaces confirmation of the connection information.

(b) Further including a step of performing a step of connecting another end side of the tube to the preset connection destination, and then reconfirming that the connection information of the first apparatus or the second apparatus to which one end side and another end side of the tube are connected and the identification information of the erroneous connection prevention tool have a relationship of being associated with each other.

(c) When a first tube and a second tube are connected to respective connection destinations different from each other between the first apparatus and the second apparatus, a step of forming a coupling tool in which a first erroneous connection prevention tool to which first identification information associated with connection information indicating a connection destination of the first tube is attached and a second erroneous connection prevention tool to which second identification information associated with connection information indicating a connection destination of the second tube is attached are coupled to each other, and connecting the one end using a first erroneous connection prevention tool for a connection of the first tube and the second erroneous connection prevention tool for a connection of the second tube is performed, in a step of moving the erroneous connection prevention tool, the coupling tool is moved to move the first and second erroneous connection prevention tools from one end sides to other end sides of the first and second tubes, respectively, and in a step of confirming the connection information, confirming connection information indicating a connection destination of the first tube based on the first identification information and confirming connection information indicating a connection destination of the second tube based on the second identification information are performed, and a step of connecting the other ends of the first and second tubes based on the respective pieces of connection information is performed.

(d) The main body portion is configured by combining a first separation portion and a second separation portion which are annular members separable from each other toward an extending direction of the tube in a state of surrounding the tube from an outer peripheral side, and a step of connecting one end of the tube is performed and then a step of separating the main body portion into the first separation portion and the second separation portion is performed, and next, in a step of moving the erroneous connection prevention tool, in a state where one side of the first separation portion and the second separation portion is disposed on a connection position side of one end of the tube, another side of the first separation portion and the second separation portion is moved as the erroneous connection prevention tool.

(e) The identification information includes a case of being at least one identification display selected from an identification display group including a color, a symbol, and a character as a visually identifiable identification display attached to the main body portion.

(f) The identification information includes a case of being protruding and recessed shapes attached to the main body portion.

(g) The identification information includes a case where the identification information is attached to the main body portion in an electronically readable state using an information recording technique selected from an information recording technique group including an RF tag, a two-dimensional code, or a barcode, and the electronically readable identification information includes management information for distinguishing an erroneous connection prevention tool to which the identification information is attached from another erroneous connection prevention tool and managing the erroneous connection prevention tool.

(h) The first apparatus and the second apparatus are single-use bags for biopharmaceutical manufacturing housed in bioreactors.

In addition, another invention is an erroneous connection prevention tool used to prevent erroneous connection of a tube connected for transferring a fluid between a first apparatus and a second apparatus, the erroneous connection prevention tool including:
a main body portion configured as an annular member; and
identification information associated with connection information indicating a connection destination of the tube to the first apparatus and the second apparatus, the identification information attached to the main body portion to identify the connection information. The erroneous connection prevention tool is used for the main body portion being disposed so as to surround the tube from an outer peripheral side, one end side of the tube being connected to a preset connection destination of an apparatus on one side of the first apparatus or the second apparatus based on the connection information associated with the identification information, then the erroneous connection prevention tool being moved from one end side to another end side of the tube along the tube, and another end side of the tube being connected to a preset connection destination of an apparatus on another side of the first apparatus or the second apparatus based on the connection information associated with the identification information.

The erroneous connection prevention tool may include the following features.

(i) When a first tube and a second tube are connected to connection destinations different from each other between the first apparatus and the second apparatus, a first erroneous connection prevention tool to which first identification information associated with connection information indicating a connection destination of the first tube is attached and a second erroneous connection prevention tool to which second identification information associated with connection information indicating a connection destination of the second tube is attached are coupled to each other to be configured as a coupling tool, and when one end of the tube is connected, the first erroneous connection prevention tool is used for connection of the first tube, and the second erroneous connection prevention tool is used for connection of the second tube.

(j) The main body portion is configured by combining a first separation portion and a second separation portion which are annular members separable from each other toward an extending direction of the tube in a state of surrounding the tube from an outer peripheral side, a connection of one end of the tube is performed and then the main body portion is separated into the first separation portion and the second separation portion, and in a state where one side of the first separation portion and the second separation portion is disposed on a connection position side of one end side of the tube, another side of the first separation portion and the second separation portion is moved as the erroneous connection prevention tool and used.

(k) When there are a plurality of the erroneous connection prevention tools, the first separation portion and the second separation portion are configured so that only the first and second separation portions associated with each other in advance can be coupled to each other and shapes of coupling portions for coupling the first and second separation portions are different from each other between the plurality of the erroneous connection prevention tools.

### Advantageous Effects of Invention

The present invention uses an erroneous connection prevention tool to which identification information is attached, the identification information associated with connection information indicating a connection destination of a tube and for identifying the connection information. The erroneous connection prevention tool is moved from the connection position of the apparatus on one end side of the tube to the other end side of the tube in a state where the tube is surrounded from the outer peripheral side by the erroneous connection prevention tool. With this operation, it is possible to carry information that one end side of the tube is connected to a correct connection destination while ensuring the identity of the tube. As a result, it is possible to confirm the correct connection destination on the other end side of the tube based on the identification information attached to the erroneous connection prevention tool and to easily perform the connection work.

### BRIEF DESCRIPTION OF DRAWINGS

FIG. 1 is a schematic diagram of a pharmaceutical factory provided with a plurality of bioreactors.

FIG. 2 is an enlarged view showing a configuration example of a bioreactor.

FIG. 3 is a plan view showing a configuration example of a ring which is an erroneous connection prevention tool.

FIG. 4 is a first operation explanatory diagram related to the connection operation of the SUT.

FIG. 5 is a second operation explanatory diagram related to the connection operation of the SUT.

FIG. 6 is a third operation explanatory diagram related to the connection operation of the SUT.

FIG. 7 is a fourth operation explanatory diagram related to the connection operation of the SUT.

FIG. 8 is an operation explanatory diagram related to a connection operation of the SUT according to a second embodiment.

FIG. 9 is a perspective view showing a configuration example of an erroneous connection prevention tool according to a third embodiment.

FIG. 10 is an operation explanatory diagram related to a connection operation of the SUT according to the third embodiment.

FIG. 11 is an operation explanatory diagram related to a connection operation of the SUT according to a fourth embodiment.

### DESCRIPTION OF EMBODIMENTS

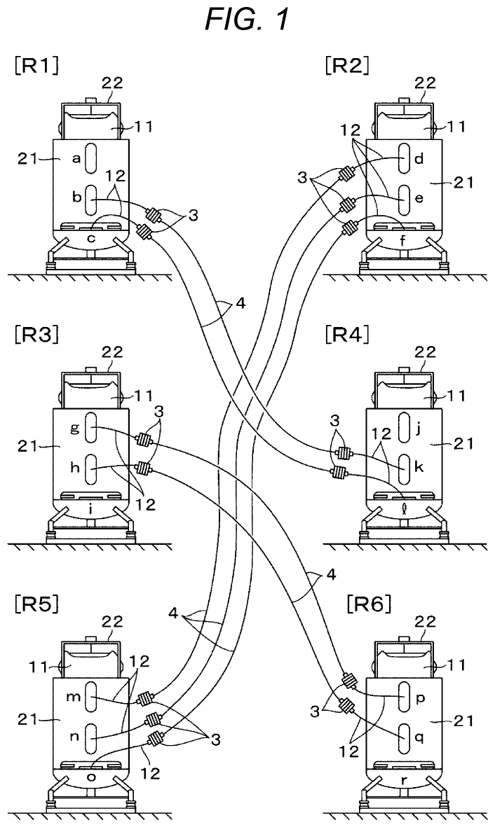

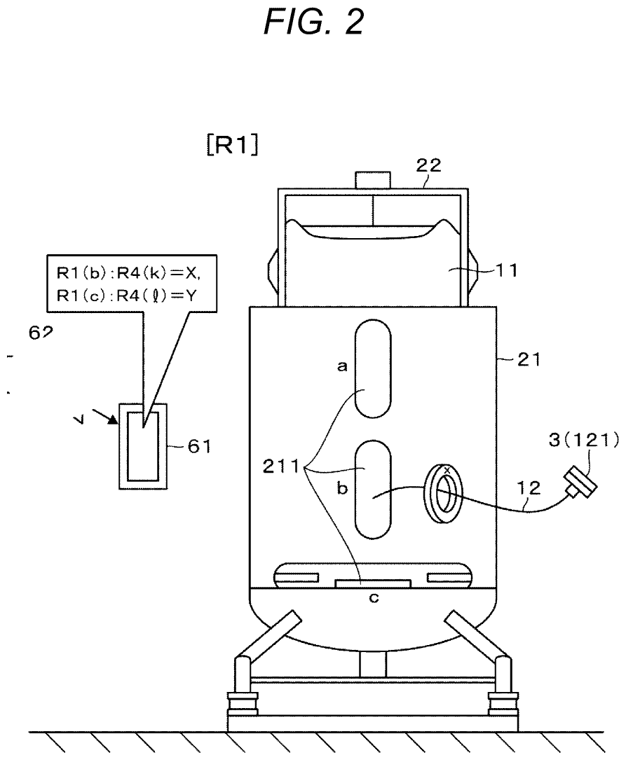

FIG. 1 schematically shows a state in which a plurality of bioreactors 21 are disposed in a pharmaceutical factory related to biopharmaceutical manufacturing. As shown in the enlarged view in FIG. 2, each bioreactor 21 serves to house a single-use bag (SUB) 11, which is a single-use apparatus.

For example, the bioreactor 21 is configured as a container whose upper surface side is opened, and has a function of adjusting the temperature of the SUB 11 housed therein. A support portion 22 for suspending and holding the SUB 11 toward the space in the bioreactor 21 is provided at a position above the opening.

The SUB 11 is a known single-use apparatus configured as a container made of a resin film. The capacity of the SUB 11 is not particularly limited, but a configuration of several liters to several hundred liters can be exemplified. In a state where the SUB 11 is suspended and housed in the bioreactor 21 and a liquid culture medium and various treatment liquids are held in the SUB 11, cell culture, objective substance purification treatment, and the like are performed.

The SUB 11 includes a port 12 made of a resin tube for receiving and dispensing a liquid, and a terminal portion of the port 12 is provided with a port side connector 121 which is a connection portion 3 for connecting to a single-use tube (SUT) 4. As illustrated in FIG. 2, in a state of the SUB 11 housed in the bioreactor 21, the port 12 is drawn out to the outside of the bioreactor 21, for example, through a window portion 211 formed in a side wall surface of the bioreactor 21.

As schematically shown in FIG. 1, a plurality of bioreactors 21 are disposed in a pharmaceutical factory, and a process for manufacturing a biopharmaceutical by connecting the SUBs 11 housed in the respective bioreactors 21 to each other is configured. It should be noted that although FIG. 1 and the like show an example in which the bioreactor 21 is fixedly disposed on the floor surface of the pharmaceutical factory, each bioreactor 21 may be configured to be movable by casters or the like.

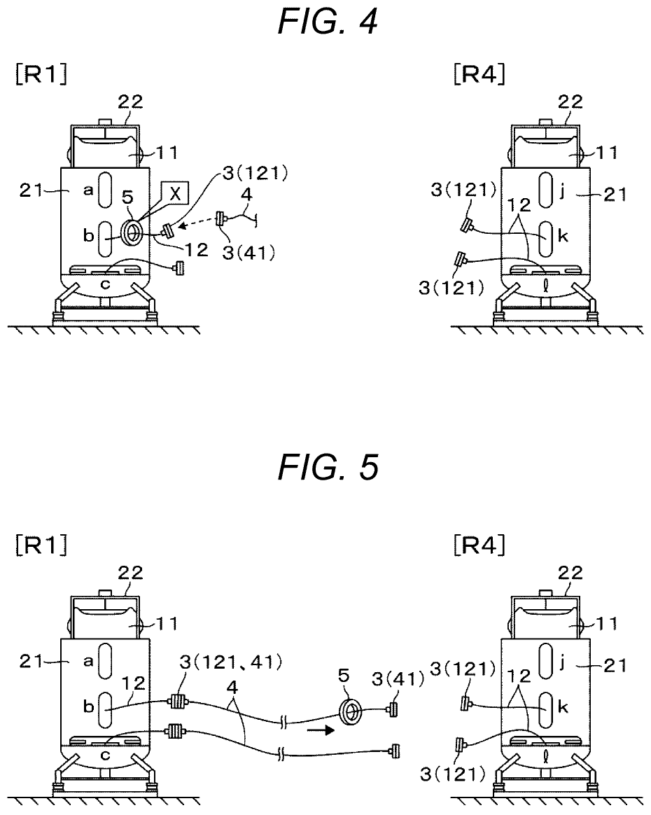

The SUBs 11 are connected to each other using a SUT 4 which is a single-use apparatus. The SUT 4 constitutes a flow path for transferring a liquid culture medium which is a fluid or various treatment liquids between the two SUBs 11. The SUT 4 is a type of known single-use apparatus including a resin tube, and both ends thereof are provided with tube side connectors 41 which are connection portions 3 (see also FIGS. 4, 5, and the like).

The port side connector 121 of the port 12 and the tube side connector 41 of the SUT 4 are standardized, and are general-purpose products capable of mutually connecting the ports 12 and the SUT 4 having common standards. On the other hand, information for individually identifying each port 12 (SUB 11) and SUT 4 is not attached to the port side connector 121 and the tube side connector 41.

In the example shown in FIG. 1, the SUB 11 is housed in each of the six bioreactors 21 denoted by identification signs R1 to R6, and the respective SUBs of R1 to R4, R2 to R5, and R3 to R6 are connected by the SUTs 4, thereby configuring the process. In addition, the SUT 4 for connecting each SUB 11 may be provided with a liquid transfer mechanism (not shown) such as a peristaltic pump.

In the above configuration, one side of the SUBs 11 connected to each other through the SUT 4 corresponds to a first apparatus of the present embodiment, and the SUB 11 on the other side different from the SUB 11 on the one side corresponds to a second apparatus.

The identification signs R1 to R6 of the bioreactors 21 and the identification signs a to r at the positions from which the ports 12 are drawn out are displayed, for example, on the outer wall surfaces of the bioreactors 21.

As described above, when different SUBs 11 are connected to each other through the SUTs 4 to constitute a process, the number of connections and the connection destinations of the SUTs 4 are not uniformly determined. These requirements are stipulated in a manufacturing instruction referred to as an “operation guide (OG)”, and are set differently for each process.

When the R1-R4 bioreactors 21 described in FIG. 1 are focused, the OG stipulates: (i) configure a process using SUBs 11 housed in the R1 and R4 bioreactors 21; (ii) connect the port 12 at a position of the sign b of R1 and the port 12 at a position of the sign k of R4 with a SUT 4; and (iii) connect the port 12 at a position of the sign c of R1 and the port 12 at a position of the sign l of R4 with a SUT4.

On the other hand, as schematically shown in FIG. 1, a plurality of bioreactors 21 are provided in the factory, and the SUBs 11 housed in the respective bioreactors 21 are connected to each other through one or a plurality of SUTs 4. In addition, as described above, since these SUTs 4 are standardized general-purpose products, it is difficult to identify them individually by visual observation. Furthermore, the bioreactors 21 housing the SUBs 11 to be connected to each other may be disposed at positions separated by several meters to several tens of meters.

On the other hand, in order to configure a process based on the OG, it is necessary to have work of identifying a target bioreactor 21 from another bioreactor 21, and connecting the SUT4 connected to a correct port 12 of a bioreactor 21 on one side to a correct port 12 of a bioreactor 21 on the other side. However, as described above, in a pharmaceutical factory in which the bioreactors 21 are disposed at positions away from each other and a large number of SUTs 4 which are difficult to identify in terms of appearance are provided, it is likely to cause a mix-up of the bioreactor 21 housing the SUB 11 to be connected, a mix-up of the port 12 to be connected to the SUT4, and a mix-up of the SUT 4 itself.

Therefore, after a worker who assembles the process completes the connection work while confirming the connection destination, work for ensuring a correct connection relationship is performed, such as performing reconfirmation by another person in charge. However, in a situation where the SUT 4 itself or the connection destination thereof is likely to be mixed up or erroneous, the reconfirmation is also a work requiring a large amount of effort.

Therefore, in the present embodiment, by using an erroneous connection prevention tool 5 which is an annular member capable of arranging the port 12 and the SUT 4 so as to surround them from the outer peripheral side, an erroneous connection of the SUT 4 to the SUB 11 is prevented and connection to a correct connection destination is performed.

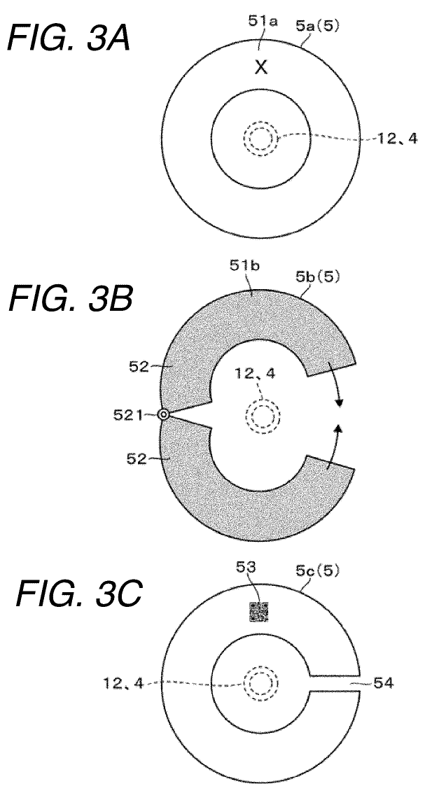

FIGS. 3(a) to 3(c) are plan views showing variations of configuration examples of the erroneous connection prevention tools 5 (5a to 5c). As shown in these figures, each of the erroneous connection prevention tools 5 is constituted by a main body portion made of an annular member.

The outline shape of the erroneous connection prevention tool 5 is not particularly limited, and FIGS. 3(a) to 3(c) show examples of the erroneous connection prevention tools 5a to 5c having circular outline shapes. The opening diameter of the annular member constituting each of the erroneous connection prevention tools 5a to 5c is formed to be larger than the outer diameter of the tube constituting the port 12 or the SUT 4, and can be arranged to surround the port 12 or the SUT 4 from the outer peripheral side. In addition, as described below, from the viewpoint of moving the erroneous connection prevention tool 5 along the port 12 or the SUT 4, the opening is preferably formed to be larger than the outer diameter of the connection portion 3 (port side connector 121 and tube side connector 41).

FIG. 3(a) shows an example in which the erroneous connection prevention tool 5a is formed of a normal annular member. In this configuration, by inserting the end portion of the port 12 or the SUT 4 into the opening, the port 12 or the SUT 4 can be arranged to be surrounded from the outer peripheral side.

In the erroneous connection prevention tool 5b shown in FIG. 3(b), the two semi-annular portions 52 are connected through a movable portion 521, and the two semi-annular portions 52 can be opened and closed with the movable portion 521 as a rotation center as with a card ring. Therefore, by opening the semi-annular portions 52, arranging the port 12 or the SUT 4 inside the erroneous connection prevention tool 5b, and then closing the semi-annular portions 52, the port 12 or the SUT 4 can be arranged to be surrounded from the outer peripheral side.

The erroneous connection prevention tool 5c shown in FIG. 3(c) has a configuration in which a notch portion 54 is formed toward a diametrical direction with respect to an annular main body portion. In this example, the gap at the notch portion 54 is formed to be smaller than the outer diameter of the tube constituting the port 12 or the SUT 4. Therefore, by pressing and deforming the tube of the port 12 or the SUT 4 made of resin and causing the tube to pass through the notch portion 54, the port 12 or the SUT 4 can be arranged to be surrounded from the outer peripheral side.

As long as an annular member that can be arranged to surround the tube of the port 12 or the SUT 4 from the outside is provided as the main body portion, the configuration of the erroneous connection prevention tool 5 is not limited to the examples shown in FIGS. 5(a) to 5(c). For example, the erroneous connection prevention tool may be constituted by a rectangular ring-shaped member, or the erroneous connection prevention tool may be constituted by a cylindrical single tube.

As described above, identification information is attached to the main body portion of the erroneous connection prevention tool 5 configured to be capable of surrounding the tube of the port 12 or the SUT 4 from the outside. The identification information enables the erroneous connection prevention tool 5 to be identified, and also serves to identify the connection destination of the SUT 4 stipulated in the OG as described below.

As the identification information, a configuration may be used in which a visually identifiable identification display is attached to the main body portion of the erroneous connection prevention tool 5. As the visually identifiable identification display, at least one identification display selected from an identification display group including colors, symbols, and characters can be exemplified.

The character may be a phonogram such as an alphabetical letter, a hiragana character, or a katakana character, or may be an ideograph such as a number. In addition, a logograph such as a kanji character may be used, or a word may be added. The symbol refers to an identification symbol other than characters such as “o and *”. As the color, it is preferable to adopt a color that can be identified at a glance, such as “Red, Blue, Black, and White”. Furthermore, the identification display may be configured by combining a plurality of colors. In addition, a plurality of types of identification displays such as colors and characters may be attached to one erroneous connection prevention tool 5.

For example, the erroneous connection prevention tool 5a in FIG. 3(a) shows an example in which “X” which is a character indication 51a is attached as identification information to a main body portion which is an annular member. In addition, the erroneous connection prevention tool 5b in FIG. 3(b) shows an example in which the color indication 51b of “gray” is attached to the main body portion.

In addition, identification information may be attached to the main body portion of the erroneous connection prevention tool 5 in an electronically readable state using an information recording technique selected from a group of information recording techniques including a radio frequency (RF) tag, a two-dimensional code, or a bar code. The electronically readable identification information includes management information for distinguishing the erroneous connection prevention tool 5 to which the identification information is attached from another erroneous connection prevention tools 5 and managing the erroneous connection prevention tool 5. As the management information, information such as symbols and characters can be set as in the above-described example.

For example, the erroneous connection prevention tool 5c in FIG. 3(c) shows an example in which a two-dimensional code 53 is attached to a main body portion as an information recording technique.

The various types of identification information attached to the erroneous connection prevention tool 5 are associated with the connection information indicating a connection destination of the SUT 4 to each SUB 11. These pieces of connection information are stipulated in the OG. Here, the identification information is characterized in that it is not information for individually identifying the SUT 4 to be connected to the port 12 of the SUB 11, but it is associated with connection information indicating a connection destination of the SUT 4 which is a general-purpose product.

For example, the OG may be displayed on an information terminal such as a tablet 61 used by a worker who performs process assembly work. When the information terminal (tablet 61) is used, a configuration may be used in which the OG is stored in the server 62, and the contents of the OG are read to the information terminal side by communication. In this case, the server 62 serves as a recording medium that records a correspondence relationship between the identification information attached to the main body portion of the erroneous connection prevention tool 5 and the connection information associated with the identification information. Then, it can be said that the server 62, the tablet 61, and the erroneous connection prevention tool 5 constitute an erroneous connection prevention system for preventing erroneous connection of the SUT 4.

It should be noted that instead of using an electronic erroneous connection prevention system, a booklet in which the contents of the OG are printed in advance may be used, and the correspondence relationship between the identification information of the erroneous connection prevention tool 5 and the identification information of the SUT 4 may be recorded in the booklet.

Reposting an example of the OG when the SUBs 11 of R1 to R4 illustrated in FIG. 1 are connected to configure the process, the OG stipulates: (i) configure a process using SUBs 11 housed in the R1 and R4 bioreactors 21; (ii) connect the port 12 at a position of the sign b of R1 and the port 12 at a position of the sign k of R4 with a SUT 4; (iii) connect the port 12 at a position of the sign c of R1 and the port 12 at a position of the sign l of R4 with a SUT4; and the like. Among these stipulations, the contents of (ii) and (iii) correspond to connection information indicating a connection destination of the SUT 4.

Therefore, for example, as shown in FIG. 2, regarding the connection information of (ii), the OG “Connect port 12 at position of sign b of SUB 11 housed in bioreactor 21 of R1 to port 12 at position of sign k of SUB 11 housed in bioreactor 21 of R4 using erroneous connection prevention tool 5 to which identification information X is attached” is displayed on the tablet 61. Hereinafter, the correspondence relationship stipulated in this OG is also expressed in a simplified form as “R1(b):R4(k)=X” or “b:k=X”.

In addition, regarding the connection information of (iii), the OG “Connect port 12 at position of sign c of SUB 11 housed in bioreactor 21 of R1 to port 12 at position of sign l of SUB 11 housed in bioreactor 21 of R4 using erroneous connection prevention tool 5 to which identification information Y is attached” is displayed on the tablet 61. The correspondence relationship stipulated in this OG is also expressed in a simplified form as “R1(c):R4(l)=Y” or “c:l=Y”.

Hereinafter, a technique of connecting the SUT 4 to a correct connection destination while preventing erroneous connection will be described with reference to FIGS. 4 to 7.

First, as shown in FIG. 4, the erroneous connection prevention tool 5 is disposed so as to surround the tube of the port 12 from the outer peripheral side by the main body portion. In this state, based on the connection information associated with the identification information X of the erroneous connection prevention tool 5, one end side of the SUT 4 is connected to the port 12 at the position of the sign b of the SUB 11 of R1 which is a preset connection destination (a step of connecting one end side of the SUT 4).

Next, as shown in FIG. 5, along the SUT 4, the erroneous connection prevention tool 5 is moved from one end side to the other end side of the SUT 4 (a step of moving the erroneous connection prevention tool 5). At this time, a plurality of SUTs 4 may be added in series according to the length of the SUT 4 and the distance between the bioreactors 21 of R1 to R4.

By the operation of moving the erroneous connection prevention tool 5, it can be said that the information “One end side of the SUT 4 is connected to the port 12 at the position of the sign b of the SUB 11 of R1” is transported while ensuring the identity of the SUT 4.

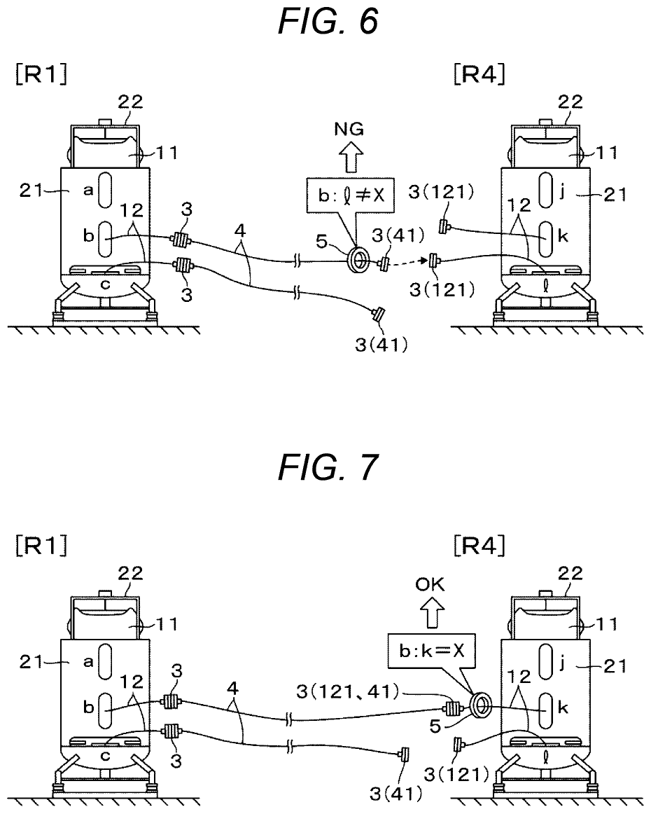

Thereafter, the connection information associated with the identification information X of the erroneous connection prevention tool 5 moved to the other end side of the SUT 4 is confirmed with reference to the OG (a step of confirming the connection information). Here, as shown in FIG. 6, it is assumed that the SUB 11 of R4 has two ports 12 at a position of the sign k and a position of the sign l.

At this time, since the connection information of “b:k=X” is associated with the identification information X of the erroneous connection prevention tool 5, it is confirmed that “the SUT 4 connected to the port 12 at the position of the sign b of the SUB 11 of R1” “cannot be connected to the port 12 at the position of the sign l of the SUB 11 of R4” (“b:l≠X” in FIG. 6).

Then, as shown in FIG. 7, based on the connection information of “b:k=X” stipulated in the OG, a work of “connecting the other end side of the SUT 4 whose one end side is connected to the port 12 at the position of the sign b of the SUB 11 of R1 to the port 12 at the position of the sign k of the SUB 11 of R4” is performed (a step of connecting to a preset connection destination).

In addition, also to the connection information of (iii) described above, the same method as the example described with reference to FIGS. 4 to 7 is applied using the erroneous connection prevention tool 5 to which the identification information Y is attached. As a result, a work is performed of “connecting the other end side of the SUT 4 whose one end side is connected to the port 12 at the position of the sign c of the SUB 11 of R1 to the port 12 at the position of the sign l of the SUB 11 of R4”.

With these works, the process of R1 to R4 shown in FIG. 1 can be correctly configured.

In addition, by using the erroneous connection prevention tool 5, a work is also facilitated of reconfirming that one end side and the other end side of the SUT 4 are connected to the correct connection destinations of the SUBs 11 of R1 to R4 by the worker who has performed the assembly or another person in charge.

That is, the erroneous connection prevention tool 5 is disposed on the other end side of the SUT 4 after the connection work is completed so as to surround the port 12 from the outer peripheral side (FIG. 7). Therefore, based on the identification information X attached to the erroneous connection prevention tool 5, connection information of “b:k=X” is obtained with reference to the OG. Based on the connection information, it is possible to reconfirm that the other end of the SUT 4 arranged inside the erroneous connection prevention tool 5 to which the identification information X is attached is connected to the correct connection destination (the port 12 at the position of the sign k).

Next, along the SUT 4, the erroneous connection prevention tool 5 is moved from the other end side to the one end side of the SUT 4. By the operation of moving the erroneous connection prevention tool 5, it can be said that the information “It has been reconfirmed that the other end side of the SUT 4 is connected to the port 12 at the position of the sign k of the SUB 11 of R4” is transported while ensuring the identity of the SUT 4.

Then, based on the connection information associated with the identification information X described above, it is possible to reconfirm that one end of the SUT 4 arranged inside the erroneous connection prevention tool 5 is connected to the correct connection destination (the port 12 at the position of the sign b) (a step of reconfirming that the connection information, and the identification information X of the erroneous connection prevention tool 5, have a relationship of being associated with each other).

According to the embodiment described above, the following effects are obtained. An erroneous connection prevention tool 5 (5a to 5c) attached with the identification information (character display 51a, color indication 51b, two-dimensional code 53, and the like in FIGS. 3(a) to 3(c)) associated with the connection information indicating the connection destination of the SUT 4 and for identifying the connection information is used. The erroneous connection prevention tool 5 is moved from the connection position of the SUB 11 on one end side of the SUT 4 to the other end side of the SUT 4 in a state where the SUT 4 is surrounded from the outer peripheral side by the erroneous connection prevention tool 5. With this operation, it is possible to carry information that one end side of the SUT 4 is connected to a correct connection destination while ensuring the identity of the SUT 4. As a result, it is possible to confirm the correct connection destination on the other end side of the SUT 4 based on the identification information attached to the erroneous connection prevention tool 5 and to easily perform the connection work.

Here, the correspondence relationship between the identification information attached to the erroneous connection prevention tool 5 and the connection information indicating the connection destination of the SUT 4 to the SUB 11 is not permanently fixed and can be stipulated again by rewriting the information on the OG side.

For example, as a work to be performed one day, in assembling a process related to the SUBs 11 housed in the bioreactors 21 of R1 to R4 described above, connection information of “b:k=X and c:l=Y” is associated with the two respective erroneous connection prevention tools 5 to which the identification information X and the identification information Y are attached in the OG. The worker can implement the assembly work by the technique described with reference to FIGS. 4 to 7.

Thereafter, for example, as a work to be performed on another day, in assembling the process related to the SUBs 11 housed in the bioreactors 21 of R2 to R5 shown in FIG. 1, the OG is updated for the three respective erroneous connection prevention tools 5 to which the identification information X, Y, and Z is attached, and the connection information of “d:m=X, e:n=Y, and f:o=Z” is associated with the three respective erroneous connection prevention tools 5. The worker can implement the assembly work of the process of the new configuration by the technique described with reference to FIGS. 4 to 7.

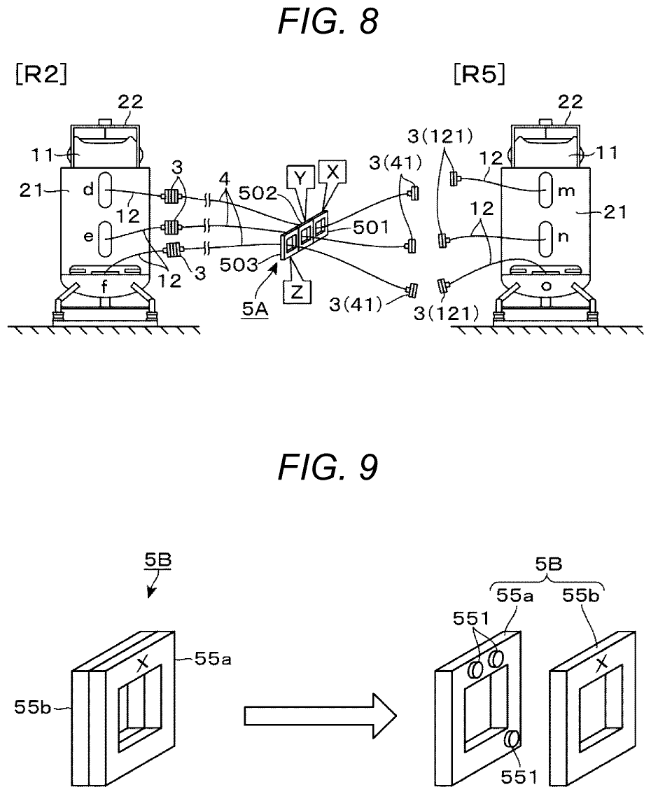

Next, the embodiment shown in FIG. 8 shows an example in which, for example, when the process related to the SUBs 11 housed in the bioreactors 21 of R2 to R5 in FIG. 1 is assembled, a plurality of erroneous connection prevention tools 501 to 503 are connected to each other to form the coupling tool 5A.

Between the SUB 11 (first apparatus) housed in the bioreactor 21 of R2 and the SUB 11 (second apparatus) housed in the bioreactor 21 of R5, a plurality of, in this example, three respective SUTs 4 are connected to connection destinations different from each other (ports 12 at positions of the signs d, e, and f of the SUB 11 of R2, and ports 12 at positions of the signs m, n, and o of the SUB 11 of R5).

As shown in FIG. 8, identification information X, Y, and Z is attached to each of the erroneous connection prevention tools 501 to 503 of the coupling tool 5A, and connection information of “d:m=X, e:n=Y, and f:o=Z” is associated with each of the OGs.

In the step of connecting one end side of the SUT 4 using the coupling tool 5A having the above configuration, the erroneous connection prevention tools 5 are disposed so as to surround the tubes of the ports 12 at the positions of the signs d, e, and f of the SUB 11 of R2 from the outer peripheral side by the respective erroneous connection prevention tools 501 to 503. Then, based on the pieces of connection information associated with the pieces of identification information X, Y, and Z of the erroneous connection prevention tools 501 to 503, respective one end sides of the three SUTs 4 are connected to the ports 12 at the positions of the signs d, e, and f which are preset connection destinations.

Next, in the step of moving the erroneous connection prevention tools 501 to 503, the entire coupling tool 5A is moved from one end sides to the other end sides of the three SUTs 4. Thereafter, in the step of confirming the connection information, the pieces of connection information associated with the pieces of identification information X, Y, and Z respectively attached to the erroneous connection prevention tools 501 to 503 are confirmed, and the respective other ends of the three SUTs 4 are connected to the ports 12 at the positions of the signs m, n, and o of the SUB 11 of R5 based on the respective pieces of connection information.

In addition, when the step of reconfirming the coincidence between the connection information and the identification information is implemented, it is reconfirmed that the other ends of the respective SUTs 4 are connected to the correct connection destinations with reference to the respective pieces of connection information stipulated in the OG based on the respective pieces of identification information X, Y, and Z attached to the erroneous connection prevention tools 501 to 503. Next, along the three SUTs 4, the entire coupling tool 5A is moved from the other end sides to the one end sides of these SUTs 4, and it is reconfirmed that one ends of the SUTs 4 arranged inside the respective erroneous connection prevention tools 501 to 503 are connected to correct connection destinations based on the pieces of connection information associated with the pieces of identification information X, Y, and Z described above.

Here, in the embodiment described with reference to FIG. 8, one of the erroneous connection prevention tools 501, 502, and 503 optionally selected from the coupling tool 5A corresponds to a first erroneous connection prevention tool, and another one of the erroneous connection prevention tools 502, 503, and 501 coupled to the one of the erroneous connection prevention tools 501, 502, and 503 corresponds to a second erroneous connection prevention tool. Then, the identification information (any one of X, Y, and Z) attached to the erroneous connection prevention tools 501, 502, and 503 which are the first erroneous connection prevention tools corresponds to the first identification information, and the identification information (any one of Y, Z, and X) attached to the erroneous connection prevention tools 502, 503, and 501 which are the second erroneous connection prevention tools corresponds to the second identification information. In addition, the SUT 4 whose one end side and the other end side are to be connected using the erroneous connection prevention tools 501, 502, and 503 which are the first erroneous connection prevention tools corresponds to a first tube, and the SUT 4 whose one end side and the other end side are to be connected using the erroneous connection prevention tools 502, 503, and 501 which are the second erroneous connection prevention tools corresponds to a second tube.

Next, the main body portion of the erroneous connection prevention tool 5B in the embodiment shown in FIG. 9 is configured by combining a first separation portion 55a and a second separation portion 55b which are annular members separable from each other in the extending direction of the SUT 4 in a state of surrounding the SUT 4 from the outer peripheral side.

Here, for example, when the connection on one end side and the other end side of the SUT 4 is performed using a plurality of erroneous connection prevention tools 5B to which respective pieces of identification information X, Y, and Z are attached, the first separation portion 55a and the second separation portion 55b constituting each erroneous connection prevention tool 5B are configured so that only the first and second separation portions 55a and 55b associated in advance can be coupled to each other.

Giving a specific example, as shown in a right view in FIG. 9, a protruding coupling portion 551 and a recessed coupling portion, which are coupling portions, are formed on the coupling surfaces to which the first and second separation portions 55a and 55b are coupled, respectively. Then, by inserting the protruding coupling portion 551 of the first separation portion 55a into the recessed coupling portion of the second separation portion 55b, only the first and second separation portions 55a and 55b are coupled to each other. It should be noted that a coupling surface on which the protruding coupling portion 551 of the first separation portion 55a is formed is displayed in the right view in FIG. 9.

In the above configuration, the shapes of the coupling portions (protruding coupling portions 551, and recessed coupling portions) are made different between the plurality of erroneous connection prevention tools 5B, and the first and second separation portions 55a and 55b cannot be coupled between the erroneous connection prevention tools 5B having different identification information X, Y, and Z. From this viewpoint, in each of the erroneous connection prevention tools 5B, it can also be said that the unique protruding and recessed shapes formed in each of the first and second separation portions 55a and 55b have a function of identification information of the erroneous connection prevention tool 5B. It should be noted that as long as the coupling surfaces have configurations capable of being coupled to each other, protruding and recessed coupling portions may be mixed on each coupling surface of the first and second separation portions 55a and 55b.

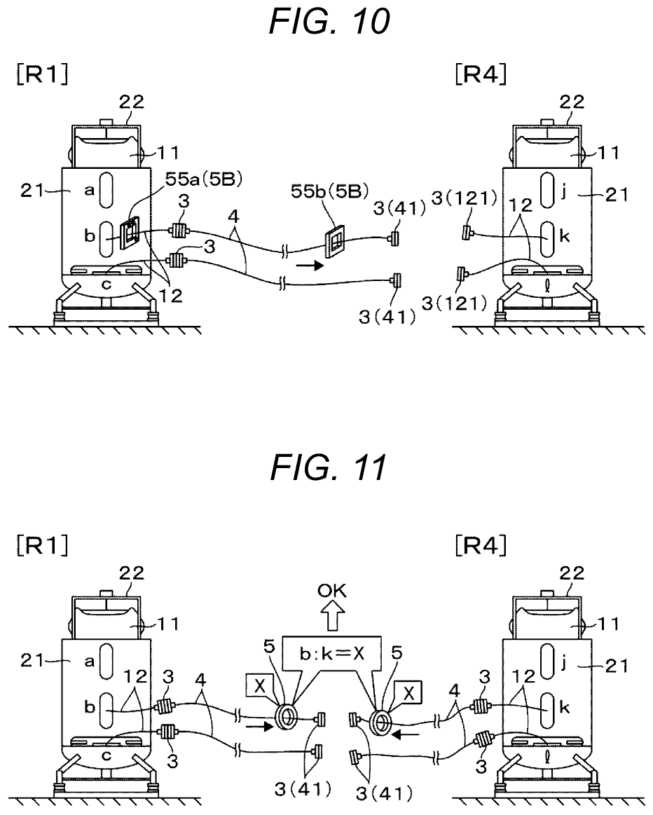

Using the erroneous connection prevention tool 5B having the configuration described above, similarly to the technique described with reference to FIG. 4, after the step of connecting one end side of the SUT 4 is performed, the step of separating the main body portion of the erroneous connection prevention tool 5B into the first separation portion 55a and the second separation portion 55b is performed. Next, in the step of moving the erroneous connection prevention tool, in a state where one side (the first separation portion 55a in the example in FIG. 10) of the first separation portion 55a and the second separation portion 55b is disposed on the connection position side of one end of the SUT 4, the other side (the second separation portion 55b in the example in FIG. 10) is moved as the erroneous connection prevention tool. According to the above technique, each of the pieces of identification information attached to the first and second separation portions 55a and 55b can be used as a work history tag indicating that the SUT 4 is connected based on the connection information associated with the identification information.

In addition, the protruding and recessed shapes used as the identification information are not limited to the case of also having a function as a coupling portion between the plurality of erroneous connection prevention tools 5B. For example, the protruding and recessed shapes may be formed, as the identification information, on the surfaces of the erroneous connection prevention tools 5a to 5c of the respective configurations described with reference to FIGS. 3(a) to 3(c) and the surfaces of the coupling tools 5A (the erroneous connection prevention tools 501 to 503) described with reference to FIG. 8.

Furthermore, the protruding and recessed shapes used as the identification information; the color, the symbol, and the character; and the identification information recorded in the electronically readable information recording technique, are not limited to when being directly recorded and formed on the surfaces of the respective erroneous connection prevention tools 5a to 5c and the coupling tool 5A. For example, a tag in which these various types of identification information are recorded and formed may be prepared, and the tag may be attached to the erroneous connection prevention tools 5a to 5c and the coupling tool 5A through a chain or the like.

Subsequently, the embodiment shown in FIG. 11 shows an example in which a step of connecting one end of the SUT 4 is performed in each of the SUBs 11 housed in both the bioreactors 21 of R1 to R4 using two erroneous connection prevention tools 5. In this case, a step of moving the erroneous connection prevention tool 5 is performed for both SUTs 4.

Then, as shown in FIG. 11, in performing the step of confirming the connection information, it is possible to replace with the confirmation of the connection information described in the OG by confirming the coincidence of the pieces of identification information X of the mutual erroneous connection prevention tools 5 moved to the other end sides of both SUTs 4.

That is, at the time of connection on one end sides of both SUTs 4, the confirmation of the connection destination “b:k=X” with reference to the OG has already been performed in both SUBs 11 of R1 to R4. Therefore, when the pieces of identification information X of the two erroneous connection prevention tools 5 match, it is confirmed that one end sides of both SUTs 4 are connected to the correct connection destinations of “b:k=X”.

Then, in the step of connecting the other end side of the SUT 4 to a preset connection destination, the process of R1 to R4 shown in FIG. 1 can be correctly configured by using the other ends of the SUTs 4 as the connection destinations. The technique shown in FIG. 11 is effective, for example, when the work of connecting one end sides of the SUT 4 on both the R1 side and the R4 side is performed in parallel.

In addition, according to the technique shown in FIG. 11, the erroneous connection prevention tool 5 can be placed halfway through the arrangement region of the SUT 4 without being dispersed in the arrangement position of the bioreactor 21. Therefore, it can also be used as a work history tag indicating that these end portions are connected to the correct connection destinations without directly confirming the connection destinations on one end side and the other end side of the SUT 4.

In addition, the technique described with reference to FIG. 11 is not limited to the erroneous connection prevention tools 5a to 5c illustrated in FIGS. 3(a) to 3(c), and may be performed using any of the coupling tool 5A described with reference to FIG. 8 or the erroneous connection prevention tool 5B shown in FIGS. 9 and 10.

Here, the configuration of the port 12 is not limited to the example shown in FIG. 2. For example, the other end side of the port 12 may have a manifold shape branched into a plurality of parts. For example, in the arrangement of the bioreactors 21 of R1 to R6 shown in FIG. 1, it is assumed that the other end side of the port 12 connected to the position of the sign b of R1 is branched into two. Then, a case is considered where it is stipulated in the OG that one of the branched ports 12 is connected to the port 12 at the position of the sign k of R4 by the SUT 4 and the other of the branched port 12 is connected to the port 12 at the position of the sign q of R6 by the SUT 4.

Also in this case, the connection information of “R1(b):R4(k)=X” is associated with the identification information X of one erroneous connection prevention tool 5, and the connection information of “R1(b):R6(q)=Y” is associated with the identification information Y of another erroneous connection prevention tool 5. Accordingly, each tube of the port 12 branched into a manifold shape can be connected to a correct connection destination. It should be noted that in the step of moving the erroneous connection prevention tool 5, by using the erroneous connection prevention tool 5b having a configuration in which the semi-annular portion 52 shown in FIG. 3(b) opens or the erroneous connection prevention tool 5c having a configuration in which the notch portion 54 shown in FIG. 3(c) is formed, the erroneous connection prevention tools 5b and 5c can be moved beyond the branch position of the tube.

In addition, the connection relationship of the SUB 11 temporarily connected through the SUT 4 may be changed as the processing proceeds. For example, after configuring the process using the SUBs 11 (first apparatus and second apparatus) housed in the bioreactors 21 of R1 to R4, these apparatuses are disconnected after a predetermined time has elapsed. Thereafter, a work of switching the connection destination of the SUB 11 housed in the bioreactor 21 of R1 to, for example, that of the SUB 11 housed in the bioreactor 21 of R6 may be required.

Even in such a case, the SUT 4 after being disconnected from the SUB 11 (first apparatus) housed in the bioreactor 21 of R1 is understood to be in a state after the “step of connecting one end side of the SUT 4” described with reference to FIG. 4 and the “step of moving the erroneous connection prevention tool 5” described with reference to FIG. 5 are performed. Then, new connection information of “R1(b):R6(q)=X” is stipulated in the OG of the switching work. Accordingly, the subsequent “step of confirming connection information” and the “step of connecting the other end side of the SUT 4 to a preset connection destination of the SUB 11 (second apparatus) housed in the bioreactor 21 of R6” can be performed.

In each embodiment described above, the case where both the first apparatus and the second apparatus are the SUBs 11 housed in the bioreactor 21 has been exemplified, but one or both of the first and second apparatuses may be other types of apparatuses. For example, a pump or a filtration device provided with an inlet portion and an outlet portion different depending on the application; a bypass port in a partition wall portion provided between adjacent processing chambers, the bypass port in which a plurality of bypass lines for transferring liquid between these processing chambers are fixedly arranged; and the like can be exemplified.

### REFERENCE SIGNS LIST

11 Single-use bag (SUB)
12 Port
121 Port side connector
21 Bioreactor
211 Window portion
22 Support portion
3 Connection portion
4 Single-use tube (SUT)
41 Tube side connector
5, 5a, 5b, 5c, 5B Erroneous connection prevention tool
501 to 503 Erroneous connection prevention tool
5A Coupling tool
51a Character indication
51b Color indication
52 Semi-annular portion
521 Movable portion
53 Two-dimensional code
54 Notch portion
55a, 55b Separation portion
551 Protruding coupling portion
61 Tablet
62 Server

1. An erroneous connection prevention method for preventing erroneous connection of a tube connected for transferring a fluid between a first apparatus and a second apparatus different from the first apparatus, the erroneous connection prevention method comprising the steps of:
using an erroneous connection prevention tool whose main body portion, configured as an annular member, is attached with identification information associated with connection information indicating a connection destination of the tube to the first apparatus or the second apparatus, the identification information for identifying the connection information, and in a state where the erroneous connection prevention tool is disposed so as to surround the tube from an outer peripheral side by the main body portion on one end side of the tube, connecting one end side of the tube to a preset connection destination of an apparatus on one side of the first apparatus or the second apparatus based on the connection information associated with the identification information of the erroneous connection prevention tool;
next, moving the erroneous connection prevention tool from one end side to another end side of the tube along the tube;
confirming the connection information associated with the identification information of the erroneous connection prevention tool moved to the other end side; and
connecting another end side of the tube to a preset connection destination of an apparatus on another side of the first apparatus or the second apparatus based on the confirmed connection information.

2. The erroneous connection prevention method according to claim 1,
wherein a step of connecting one end of the tube in each of the first apparatus and the second apparatus using two erroneous connection prevention tools and a step of moving the erroneous connection prevention tool are performed, and
wherein in a step of connecting another end side of the tube to the connection destination, other ends of the tubes are set as the connection destinations.

3. The erroneous connection prevention method according to claim 2, wherein in a step of confirming the connection information, confirming matching between the pieces of identification information of the erroneous connection prevention tools moved to the other end sides replaces confirmation of the connection information.

4. The erroneous connection prevention method according to claim 1, further comprising a step of performing a step of connecting another end side of the tube to the preset connection destination, and then reconfirming that the connection information of the first apparatus or the second apparatus to which one end side and another end side of the tube are connected and the identification information of the erroneous connection prevention tool have a relationship of being associated with each other.

5. The erroneous connection prevention method according to claim 1,
wherein when a first tube and a second tube are connected to respective connection destinations different from each other between the first apparatus and the second apparatus, a step of forming a coupling tool in which a first erroneous connection prevention tool to which first identification information associated with connection information indicating a connection destination of the first tube is attached and a second erroneous connection prevention tool to which second identification information associated with connection information indicating a connection destination of the second tube is attached are coupled to each other, and connecting the one end using a first erroneous connection prevention tool for a connection of the first tube and the second erroneous connection prevention tool for a connection of the second tube is performed,
wherein in a step of moving the erroneous connection prevention tool, the coupling tool is moved to move the first and second erroneous connection prevention tools from one end sides to other end sides of the first and second tubes, respectively, and
wherein in a step of confirming the connection information, confirming connection information indicating a connection destination of the first tube based on the first identification information and confirming connection information indicating a connection destination of the second tube based on the second identification information are performed, and a step of connecting the other ends of the first and second tubes based on the respective pieces of connection information is performed.

6. The erroneous connection prevention method according to claim 1,
wherein the main body portion is configured by combining a first separation portion and a second separation portion which are annular members separable from each other toward an extending direction of the tube in a state of surrounding the tube from an outer peripheral side, and a step of connecting one end of the tube is performed and then a step of separating the main body portion into the first separation portion and the second separation portion is performed, and
wherein next, in a step of moving the erroneous connection prevention tool, in a state where one side of the first separation portion and the second separation portion is disposed on a connection position side of one end of the tube, another side of the first separation portion and the second separation portion is moved as the erroneous connection prevention tool.

7. The erroneous connection prevention method according to claim 1, wherein the identification information includes a case of being at least one identification display selected from an identification display group including a color, a symbol, and a character as a visually identifiable identification display attached to the main body portion.

8. The erroneous connection prevention method according to claim 1, wherein the identification information includes a case of being protruding and recessed shapes attached to the main body portion.

9. The erroneous connection prevention method according to claim 1,
wherein the identification information includes a case where the identification information is attached to the main body portion in an electronically readable state using an information recording technique selected from an information recording technique group including an RF tag, a two-dimensional code, or a barcode, and
wherein the electronically readable identification information includes management information for distinguishing an erroneous connection prevention tool to which the identification information is attached from another erroneous connection prevention tool and managing the erroneous connection prevention tool.

10. The erroneous connection prevention method according to claim 1, wherein the first apparatus and the second apparatus are single-use bags for biopharmaceutical manufacturing housed in bioreactors.

11. An erroneous connection prevention tool used to prevent erroneous connection of a tube connected for transferring a fluid between a first apparatus and a second apparatus, the erroneous connection prevention tool comprising:
a main body portion configured as an annular member; and
identification information associated with connection information indicating a connection destination of the tube to the first apparatus and the second apparatus, the identification information attached to the main body portion to identify the connection information,
wherein the erroneous connection prevention tool is used for the main body portion being disposed so as to surround the tube from an outer peripheral side, one end side of the tube being connected to a preset connection destination of an apparatus on one side of the first apparatus or the second apparatus based on the connection information associated with the identification information, then the erroneous connection prevention tool being moved from one end side to another end side of the tube along the tube, and another end side of the tube being connected to a preset connection destination of an apparatus on another side of the first apparatus or the second apparatus based on the connection information associated with the identification information.

12. The erroneous connection prevention tool according to claim 11, wherein when a first tube and a second tube are connected to connection destinations different from each other between the first apparatus and the second apparatus, a first erroneous connection prevention tool to which first identification information associated with connection information indicating a connection destination of the first tube is attached and a second erroneous connection prevention tool to which second identification information associated with connection information indicating a connection destination of the second tube is attached are coupled to each other to be configured as a coupling tool, and when one end of the tube is connected, the first erroneous connection prevention tool is used for connection of the first tube, and the second erroneous connection prevention tool is used for connection of the second tube.

13. The erroneous connection prevention tool according to claim 11, wherein the main body portion is configured by combining a first separation portion and a second separation portion which are annular members separable from each other toward an extending direction of the tube in a state of surrounding the tube from an outer peripheral side, a connection of one end of the tube is performed and then the main body portion is separated into the first separation portion and the second separation portion, and in a state where one side of the first separation portion and the second separation portion is disposed on a connection position side of one end side of the tube, another side of the first separation portion and the second separation portion is moved as the erroneous connection prevention tool and used.

14. The erroneous connection prevention tool according to claim 13, wherein when there are a plurality of the erroneous connection prevention tools, the first separation portion and the second separation portion are configured so that only the first and second separation portions associated with each other in advance can be coupled to each other and shapes of coupling portions for coupling the first and second separation portions are different from each other between the plurality of the erroneous connection prevention tools.
